(19) United States
(12) Patent Application Publication
(10) Pub. No.: US 2019/0011737 A1
(43) Pub. Date: Jan. 10, 2019

(54) DISPLAY DEVICE

(71) Applicant: BOE Technology Group Co., Ltd., Beijing (CN)

(72) Inventors: Guangkui Qin, Beijing (CN); Miki Kashima, Beijing (CN)

(21) Appl. No.: 15/909,048

(22) Filed: Mar. 1, 2018

(30) Foreign Application Priority Data
Jul. 10, 2017 (CN) 201720832921.3

(51) Int. Cl. G02F 1/1335; G02F 1/1334; G02F 1/167

(52) U.S. Cl. CPC G02F 1/1336; G02F 1/1334; G02F 1/167; G02F 2001/133616; G02F 1/133504; G02F 2001/13345; G02F 2001/133541; G02F 1/133528

(57) ABSTRACT

Disclosed is a display device, which includes: a display panel, and a frontlight source arranged on at least one side of the display panel, where light emitted from the frontlight source is collimated light in the direction perpendicular to a light incidence face of the display panel. The light emitted from the frontlight source can only be incident onto the display panel in the direction perpendicular to the light incidence face of the display panel, and the light emitted from the frontlight source is collimated light with a uniformly distributed intensity in the direction perpendicular to the light incidence face of the display panel, so there is a uniform intensity distribution of light beams incident onto the display panel, thus resulting in high uniformity of brightness, and high contrast in the display device.

This application claims the benefit of Chinese Patent Application No. 201720832921.3, filed with the Chinese Patent Office on Jul. 10, 2017, which is hereby incorporated by reference in its entirety.

### FIELD

The present disclosure relates to the field of display technologies, and particularly to a display device.

### BACKGROUND

As the display technologies are advancing constantly, display products have been gradually widespread throughout our life.

A reflective type of display device can display an image using ambient light as a light source, and has been widely favored among its users due to its advantages of a high contrast, low power consumption, a small thickness, a low weight, etc.

The reflective type of display device can perform its display function perfectly under a condition with sufficient ambient light; and a display effect of the image may be seriously degraded when there are insufficient ambient light, or in a dark room. Generally when there are insufficient light in a surrounding environment, a frontlight source needs to be added to assist display. However there is such a small difference in refractive index between the front light-guiding plate and a bonding adhesive, that the technical solution in which the frontlight source assists the display can only be used to adjust the uniformity of brightness for the reflective type of display device with a small size to a limited extent, but have no adjusting effect on the uniformity of brightness for the reflective type of display device with a large size.

Furthermore scattering type of display device (which is also referred as lightwave guiding display device) has been increasingly recognized due to its advantages of a high response speed, low power consumption, a high transmittivity, etc. It is characterized in that a liquid crystal box itself can operate as a lightwave guiding plate, and also used to display. However the light from the light source required in this display technology is incident onto the side of the display panel, and as there is an increasing distance between the liquid crystal molecules and the light source, there is a decreasing amount of light guided into the display panel, so there is also a decreasing amount of light to be scattered out of the liquid crystal molecules, thus degrading the uniformity of brightness, and the contrast throughout the display panel, which may seriously affect the quality of the displayed image.

As can be apparent from the description above, there is low uniformity of brightness, and low contrast in the display device in the prior art, thus how to improve the uniformity of brightness, and the contrast in the display device is to be solved.

### SUMMARY

Embodiments of the disclosure provide a display device. The display device includes: a display panel, and a frontlight source arranged on at least one side of the display panel, where light emitted from the frontlight source is collimated light in the direction perpendicular to a light incidence face of the display panel.

### BRIEF DESCRIPTION OF THE DRAWINGS

FIG. 1A to FIG. 1E are schematic structural diagrams respectively of a display device according to embodiments of the disclosure.

FIG. 2A and FIG. 2B are schematic diagrams respectively of a frontlight source emitting light according to embodiments of the disclosure.

FIG. 3A and FIG. 3B are schematic structural diagrams respectively of a frontlight source according to embodiments of the disclosure.

FIG. 4 is a schematic diagram of an internal structure of an asymmetric scattering film.

FIG. 5A and FIG. 5B are schematic diagrams respectively illustrating the adjustness of brightness in the display device illustrated in FIG.1E.

### DETAILED DESCRIPTION OF THE EMBODIMENTS

Particular implementations of a display device according to an embodiment of the disclosure will be described below in details with reference to the drawing. It shall be noted that the embodiments to be described here are only a part but not all of the embodiments of the disclosure. Based upon the embodiments here of the disclosure, all of the other embodiments which can occur to those ordinarily skilled in the art without any inventive effort shall come into the scope of the disclosure as claimed.

The shapes and sizes of respective components in the drawings will not reflect any real proportion of a display device, but are only intended to illustrate the disclosure of the disclosure by way of an example.

It shall be noted that, the display device according to the embodiment of the disclosure may be a reflective type of display device, or a scattering type of display device. The reflective type of display device is not limited to the one that only reflects light, but also includes the transflective one that reflects and transmits light.

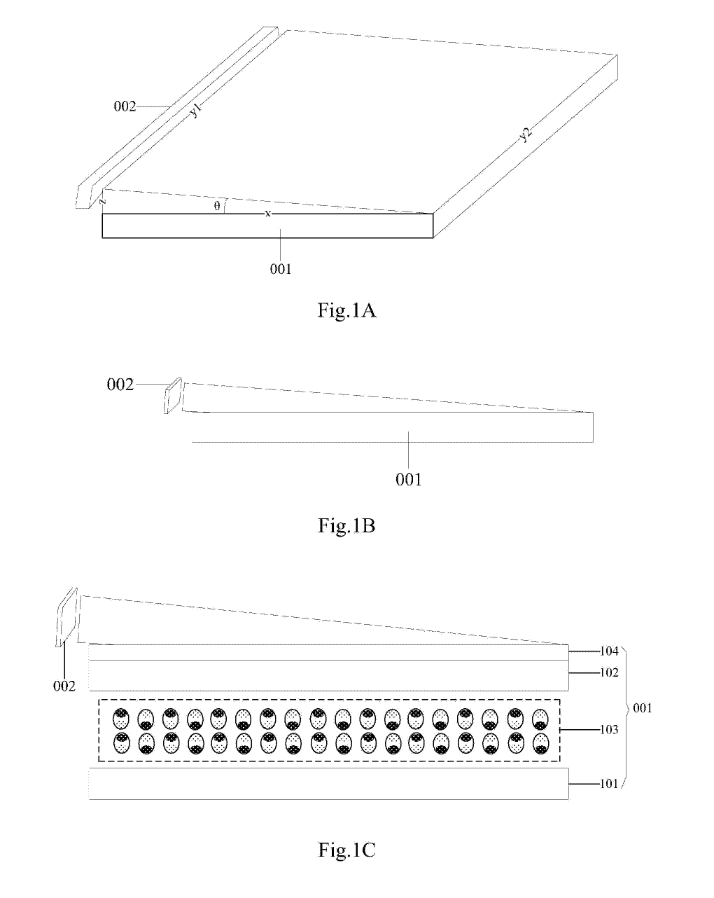

An embodiment of the disclosure provides a display device as illustrated in FIG. 1A to

FIG. 1E, where the display device includes a display panel 001, and a frontlight source 002 arranged on at least one side of the display panel 001, where:

light emitted from the frontlight source 002 are collimated light in the direction perpendicular to a light incidence face of the display panel 001.

In the display device above according to the embodiment of the disclosure, the light emitted from the frontlight source 002 can only be incident onto the display panel 001 in the direction perpendicular to the light incidence face of the display panel 001, and the light emitted from the frontlight source 002 are collimated light with a uniformly distributed intensity in the direction perpendicular to the light incidence face of the display panel 001, so there is a uniform intensity distribution of light beams incident onto the display panel 001, thus resulting in high uniformity of brightness, and high contrast in the display device.

It shall be noted in the display device above according to the embodiment of the disclosure, the light emitted from the frontlight source 002 in the direction perpendicular to the light incidence face of the display panel 001 can be collimated light, but also can be light with a small divergence angle, although the light with a small divergence angle can improve the uniformity of brightness, and the contrast in the display device with a relatively small effect as compared with the collimated light.

In some embodiments, in order to enable the collimated light emitted from the frontlight source 002 in the direction perpendicular to the light incidence face of the display panel 001 to be incident onto the display plane 001, in the display device above according to the embodiment of the disclosure, a relative position of the frontlight source 002 to the display panel 001 can be preset as needed in reality. For example, when the display panel 001 is arranged horizontally, the frontlight source 002 can be located above the top left of the light incidence face of the display panel 001 as illustrated in FIG. 1A and FIG. 1B, and/or above the top right of the light incidence face of the display panel 001; and in another example, when the display panel 001 is arranged vertically, the frontlight source 002 can be located above the front left of the light incidence face of the display panel 001, and/or above the front right of the light incidence face of the display panel 001, so that the light emitted from the frontlight source 002 can be incident obliquely on the surface of the display panel 001, thus resulting in an incident light plane on which a light intensity is distributed uniformly.

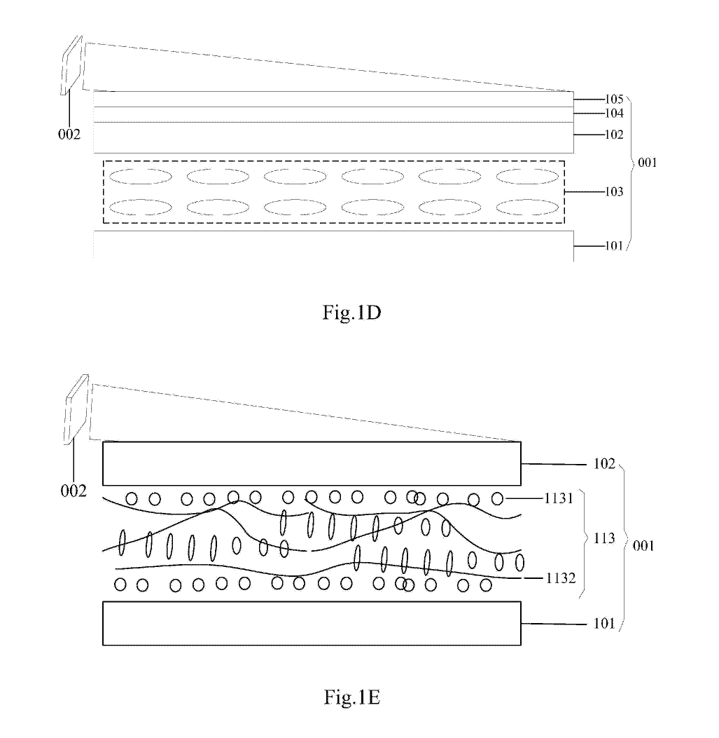

In an implementation, in the display device above according to the embodiment of the disclosure, the shape of the frontlight source 002 can be arranged as long straight bars as illustrated in FIG. 2A and FIG. 2B, or can be arranged as another shape, although the embodiment of the disclosure will not be limited thereto. For the sake of understanding the display device above according to the embodiment of the disclosure, the frontlight source 002 will be arranged as long straight bar throughout the following description.

In some embodiments, in the display device above according to the embodiment of the disclosure, as illustrated in FIG. 1A, there is a rectangular wave front of the light emitted from the frontlight source 002, and a shorter side of the wave front (the thickness of the frontlight source 002) is perpendicular to the light incidence face of the display panel 001, that is, light emitted from the frontlight source 002 in the extension direction of the shorter side z of the wave front is collimated light.

Since the light emitted from the frontlight source 002 can only be incident onto the display panel 011 in the direction perpendicular to the light incidence face of the display panel 001, the uniformity of brightness, and the contrast in the display device will not be affected by whether light emitted from the frontlight source 002 in the extension direction of a longer side y1 of the wave front (the length of the frontlight source 002) is divergent, so that in an implementation, in the display device above according to the embodiment of the disclosure, the light emitted from the frontlight source 002 in the extension direction of the longer side y1 of the wave front may or may not be collimated light, that is, the light emitted from the frontlight source 002 in the extension direction of the longer side y1 of the wave front may be parallel light, or light with a small divergence angle, or may be light with a large divergence angle, although the embodiment of the disclosure will not be limited thereto.

In some embodiments, in the display device above according to the embodiment of the disclosure, as illustrated in FIG. 1A, the light incidence face of the display panel 001 is a rectangle, the frontlight source 002 is arranged on a longer side y2 of the display panel 001, and the longer side y1 of the wave front is parallel to the longer side y2 of the display panel 001. In some embodiments, in order to further improve the uniformity of brightness, and the contrast of the display device, the frontlight source 002 can be arranged on both of longer sides y2 of the display panel 001.

In some embodiments, in the display device above according to the embodiment of the disclosure, as illustrated in FIG. 1A, when the frontlight source 002 is arranged above the top left of the light incidence of the display panel 001, the tangent of an angle 0 between the normal to the wave front of the light emitted from the frontlight source 002(i.e., the propagation direction of the light) and a shorter side x of the display panel 001 is the ratio of a shorter side z of the wave front to the shorter side x of the display panel 001.

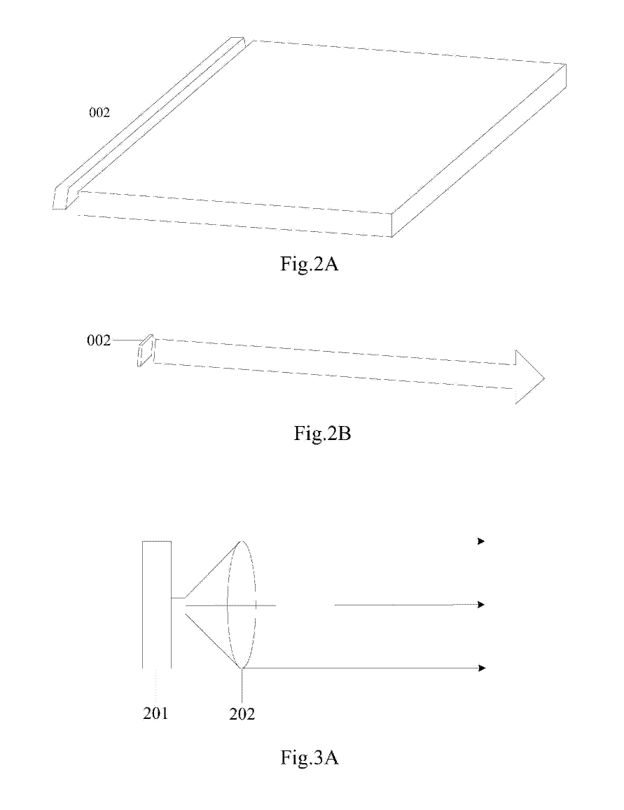

In an implementation, in the display device above according to the embodiment of the disclosure, the frontlight source 002 can be embodied in a number of implementations, and as illustrated in FIG. 3A, for example, the frontlight source 002 can include a strip-shaped light source 201, and a strip-shaped lens 202 arranged on a light exit path of the strip-shaped light source 201. In another example, as illustrated in FIG. 3B, the frontlight source 002 can be a laser light source 203. In still another example, the frontlight source 002 can include a plurality of point light sources arranged in an array, and lenses corresponding to the respective point light sources in a one-to-one manner, where the lenses can be general lenses, or can be planar lenses, although the embodiment of the disclosure will not be limited thereto; and in some embodiments, the respective point light sources are located respectively on the focuses of their corresponding lenses.

In some embodiments, in the display device above according to the embodiment of the disclosure, the strip-shaped light source 201 can be a lamp bar in which a plurality of point light sources are arranged, or can be a strip-shaped planar light source, e.g., an Organic Light-Emitting Diode (OLED), although the embodiment of the disclosure will not be limited thereto.

Moreover in the display device above according to the embodiment of the disclosure, the type of the light source can be a Light-Emitting Diode (OLED), a cold cathode tube, or another light source, although the embodiment of the disclosure will not be limited thereto.

In an implementation, in the display device above according to the embodiment of the disclosure, the display panel 001 can be embodied in a number of structures, and as illustrated in FIG. 1C and FIG. 1D, for example, the display panel 001 can include: an array substrate 101 and an opposite substrate 102 arranged opposite to each other, a display medium layer 103 arranged between the array substrate 101 and the opposite substrate 102, and an asymmetric scattering film 104 arranged on the side of the opposite substrate 101 away from the array substrate 101.

In some embodiments, in order to further improve the uniformity of brightness on the display panel 001, in the display device above according to the embodiment of the disclosure, a primary scattering direction of the asymmetric scattering film 104 may be the same as the incidence direction of the light of the frontlight source 002.

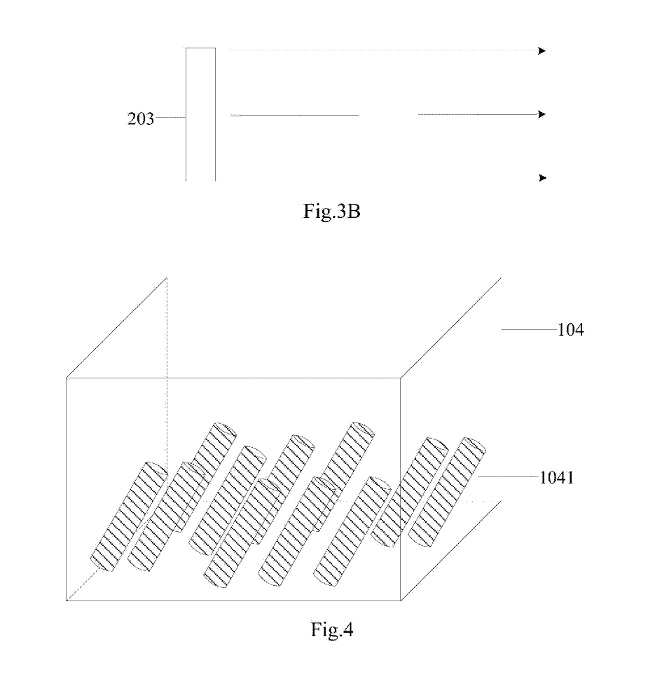

In some embodiments, as illustrated in FIG. 4, an inclination direction of the scattering element 1041 is the primary scattering direction of the asymmetric scattering film 104, and as can be apparent, the scattering elements 1041 are inclined rightward, then the frontlight source 002 can be arranged above the top right of the light incidence of the display panel 001, so that the primary scattering direction of the asymmetric scattering film 104 will be the same as the incidence direction of the light of the frontlight source 002. Of course, the frontlight source 002 can alternatively be arranged above the top left of the light incidence of the display panel 001, or perpendicular to the paper, although the embodiment of the disclosure will not be limited thereto.

In an implementation, in the display device above according to the embodiment of the disclosure, the display medium layer 103 can be arranged as an electronic ink layer as illustrated in FIG. 1C; or can be arranged as a liquid crystal layer (as illustrated in FIG. 1D), or an electrochromic layer, although the embodiment of the disclosure will not be limited thereto.

Furthermore in the display device above according to the embodiment of the disclosure, when the display medium layer 103 is arranged as a liquid crystal layer or an electrochromic layer, the display panel 001 further includes a circular polarization sheet 105 arranged on the side of the asymmetric scattering film 104 away from the array substrate 101 as illustrated in FIG. 1D. In some embodiments, the frontlight source 002 shall be slightly higher than a layer where the circular polarization sheet 105 is located, so that the light of the frontlight source 002 illuminating the display panel 001 can be converted by the circular polarization sheet 105 into circularly-polarized light with a polarization axis helically varying as the light is advancing.

In another example, in an implementation, in the display device above according to the embodiment of the disclosure, as illustrated in FIG. 1E, the display panel 001 can include: an array substrate 101 and an opposite substrate 102 arranged opposite to each other, and a hybrid liquid crystal layer 113 arranged between the array substrate 101 and the opposite substrate 102, where:

the hybrid liquid crystal layer 113 includes: liquid crystal molecules 1131 aligned perpendicular to the incidence direction of the light of the frontlight source 002, and a polymer network 1132 surrounding the liquid crystal molecules 1131.

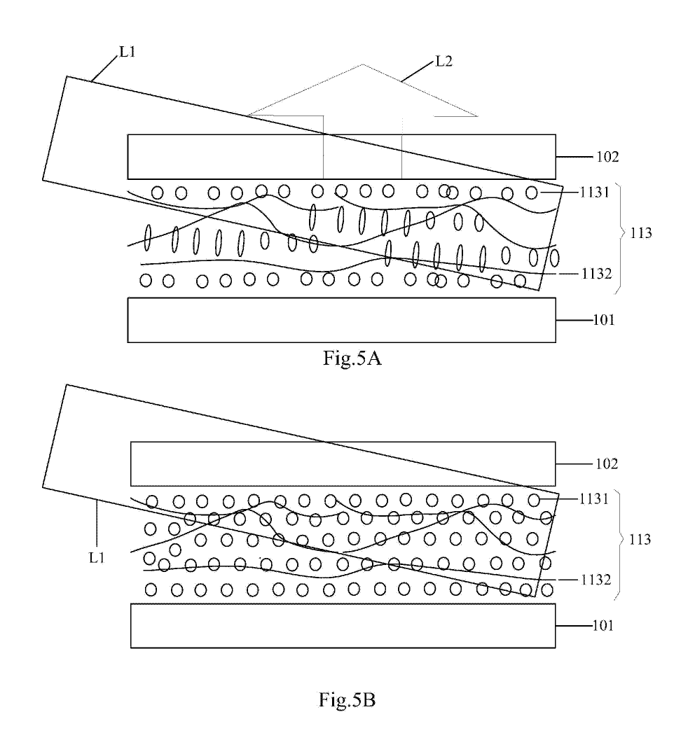

In the display device as illustrated in FIG. 1E according to the embodiment of the disclosure, brightness adjusting can be performed through switching the liquid crystal molecules 1131 between transparent and scattering states. As illustrated in FIG. 5A, when the light L1 emitted from the frontlight source 002 are incident obliquely onto the hybrid liquid crystal layer 113, if an image needs to be displayed, then voltage will be applied to a certain area, and the liquid crystal molecules 1131 in the area will be deflected accordingly, and the orientations of the liquid crystal molecules 1131 will be disordered due to the polymers, so that they are in the scattered state, and the light entering the hybrid liquid crystal layer 113 are scattered, so that the scattered light L2 exits from the opposite substrate 102 side to thereby display the image; and as illustrated in FIG. 5B, when no voltage is applied, the liquid crystal molecules 1131 are in the transparent state, and the light L1 emitted from the frontlight source 002 exits from the array substrate 101 side directly through the liquid crystal molecules 1131, so that there are no light exiting the surface of the opposite substrate 102 away from the array substrate 101.

Furthermore in the display device as illustrated in FIG. 1E according to the embodiment of the disclosure, when the light exits from the array substrate 101 side, the display panel 001 can further include an absorbing layer arranged on the side of the array substrate 101 away from the opposite substrate 102 (not illustrated in FIG. 1E) to absorb the light exiting from the array substrate 101 side. In some embodiments, the absorbing layer can be a black absorbing structure, alternatively it can be another component capable of absorbing light, although the embodiment of the disclosure will not be limited thereto.

It shall be noted that the display device above according to the embodiment of the disclosure can be a mobile phone, a tablet computer, a TV set, a monitor, a notebook computer, a digital photo frame, a navigator, a smart watch, a fitness wrist band, a personal digital assistant, or any other product or component capable of displaying, although the embodiment of the disclosure will not be limited thereto.

The display device above according to the embodiment of the disclosure includes: a display panel, and a frontlight source arranged on at least one side of the display panel, where light emitted from the frontlight source are collimated light in the direction perpendicular to a light incidence face of the display panel. The light emitted from the frontlight source can only be incident onto the display panel in the direction perpendicular to the light incidence face of the display panel, and the light emitted from the frontlight source are collimated light with a uniformly distributed intensity in the direction perpendicular to the light incidence face of the display panel, so there is a uniform intensity distribution of light beams incident onto the display panel, thus resulting in high uniformity of brightness, and high contrast in the display device.

Evidently those skilled in the art can make various modifications and variations to this disclosure without departing from the spirit and scope of this disclosure. Thus this disclosure is also intended to encompass these modifications and variations thereto so long as the modifications and variations come into the scope of the claims appended to this disclosure and their equivalents.

1. A display device, comprising: a display panel, and a frontlight source arranged on at least one side of the display panel, wherein:
light emitted from the frontlight source is collimated light in a direction perpendicular to a light incidence face of the display panel.

2. The display device according to claim 1, wherein there is a rectangular wave front of the light emitted from the frontlight source, and a shorter side of the wave front is perpendicular to the light incidence face of the display panel.

3. The display device according to claim 2, wherein light emitted from the frontlight source in a direction along a longer side of the wave front is collimated light.

4. The display device according to claim 2, wherein the light incidence face of the display panel is a rectangle, the frontlight source is arranged on a longer side of the display panel, and a longer side of the wave front is parallel to a longer side of the display panel.

5. The display device according to claim 3, wherein a tangent of an angle between a normal to the wave front, and a shorter side of the display panel is a ratio of the shorter side of the wave front to the shorter side of the display panel.

6. The display device according to claim 1, wherein the frontlight source comprises a strip-shaped light source, and a strip-shaped lens arranged on a light exit path of the strip-shaped light source.

7. The display device according to claim 1, wherein the frontlight source comprises a plurality of point light sources arranged in an array, and lenses corresponding to the plurality of point light sources in a one-to-one manner respectively.

8. The display device according to claim 1, wherein the frontlight source is a laser light source.

9. The display device according to claim 1, wherein the display panel comprises:
an array substrate and an opposite substrate arranged opposite to each other;
a display medium layer arranged between the array substrate and the opposite substrate; and
an asymmetric scattering film arranged on a side of the opposite substrate away from the array substrate.

10. The display device according to claim 9, wherein a primary scattering direction of the asymmetric scattering film is same as an incidence direction of the light of the frontlight source.

11. The display device according to claim 10, wherein the display medium layer is an electronic ink layer.

12. The display device according to claim 9, wherein the display panel further comprises a circular polarization sheet arranged on a side of the asymmetric scattering film away from the array substrate.

13. The display device according to claim 12, wherein the display medium layer is arranged as a liquid crystal layer or an electrochromic layer.

14. The display device according to claim 1, wherein the display panel comprises:
an array substrate and an opposite substrate arranged opposite to each other, and
a hybrid liquid crystal layer arranged between the array substrate and the opposite substrate;
wherein the hybrid liquid crystal layer comprises: liquid crystal molecules aligned perpendicular to an incidence direction of the light of the frontlight source, and a polymer network surrounding the liquid crystal molecules.

15. The display device according to claim 14, wherein the display panel further comprises an absorbing layer arranged on a side of the array substrate away from the opposite substrate.
